(19) United States
(12) Patent Application Publication
(10) Pub. No.: US 2018/0332605 A1
(43) Pub. Date: Nov. 15, 2018

(54) DEVICE AND METHODS FOR MULTIPLEXING TRANSMISSIONS WITH DIFFERENT TTI DURATION

(71) Applicant: INTERDIGITAL PATENT HOLDINGS, INC., Wilmington, DE (US)

(72) Inventor: Ghyslain Pelletier, Montreal (CA)

(73) Assignee: INTERDIGITAL PATENT HOLDINGS, INC., Wilmington, DE (US)

(21) Appl. No.: 15/769,958

(22) PCT Filed: Nov. 4, 2016
(86) PCT No.: PCT/US2016/060481

§ 371 Date: Apr. 20, 2018

Related U.S. Application Data
(60) Provisional application No. 62/250,791, filed on Nov. 4, 2015.

(51) Int. Cl. H04W 72/12

(52) U.S. Cl. CPC H04W 72/1289

(57) ABSTRACT

A wireless transmit/receive unit, WTRU and methods of using a WTRU within a wireless communications network include communicating with a serving cell in the wireless communications network and determining, based on downlink control information whether the WTRU shall transmit with a first transmission time interval, TTI, length, using a first set of transmission resources, or a second TTI length, using a second set of transmission resources. Alternatively, determining based on said DCI, that the serving cell has indicated that the WTRU should use a first TTI on a physical uplink channel to communicate with the serving cell, or whether said DCI indicates that the WTRU should use a second TTI that is less than the first transmission time interval to communicate with the wireless communication network on the physical uplink channel or whether the WTRU should transmit using carrier aggregation.

### BACKGROUND

In a wireless communication network, such as a Long Term Evolution (LTE) system or New Radio (NR), a wireless transmit/receive unit (WTRU) device may access resources of the communication system. Latency associated with transmission of data in a communication system may have one or more latency components. A latency component may be the time to perform the transmission of a transport block, which time may be referred to as a Transmission Time Interval (TTI). Such TTI may be tied to a specific numerology associated with the transmission method and to a specific number of transmission symbols associated with the transmission. Other latency components may include processing time at a receiver, e.g., time decoding a transmission, transmission of feedback (e.g. ACK or NACK) and/or one or more retransmissions with one or more latency components.

### SUMMARY

Systems, methods, and instrumentalities are disclosed for multiplexing transmissions with different durations, for example transmissions that are associated with different TTI lengths. Latency may be reduced (e.g., in an LTE system and/or in a NR system), for example, by multiplexing transmissions with different TTI durations or associated with different transmission numerologies. TTI duration may be modeled based on defining one or more cell(s) for a given carrier frequency, for example that may be associated with different TTI lengths and/or transmission durations. For example, the different transmission durations may be achieved by time-shifting one or more of the cells. In order to support signaling techniques that allow for concurrent and/or complementary scheduling of transmissions associated with different duration, a logical structure for the physical layer resources (e.g., a cell, a spectrum block, etc.) may configured to correspond to a secondary cell (“SCell”). A primary cell (“PCell”) may logically maintain a first transmission duration (e.g., a first TTI length such as a legacy TTI length). The SCell may be configured with a second transmission duration (e.g., a second TTI length or a shortened TTI length). One or more of a PCell or an SCell may be configured with either the legacy or shortened TTI length (e.g., a shorter duration TTI (ShTTI).

By associating different TTI lengths with different cells, the LTE carrier aggregation framework can be utilized to support multiplexing of transmissions of different durations. For example, carrier aggregation signaling, including cross-carrier scheduling mechanisms, can be used to different scheduling grants and assignments of varying length. For example, a WTRU may determine a TTI duration (e.g., first or second TTI length) applicable to a transmission. For example, a WTRU may determine a TTI duration using cross-carrier scheduling. A WTRU may be configured to associate a given cell identity (e.g., servCellID) with a given transmission duration. Different cell identities (e.g., different servCellIDs) may be associated with different transmission durations/different TTI lengths. When a WTRU receives scheduling information applicable to a given cell identity, the WTRU may determine the associated TTI length based on the configuration received for that cell identity.

A WTRU may determine a TTI length and/or transmission duration based on one or more parameters and/or received fields. For example, a WTRU may associate a given TTI duration with a given transmission mode (TM). A TTI duration may be indicated by a Carrier Indicator Field (CIF), for example where certain values of the CIF are associated with SCells configured with a given TTI durations such as a ShTTI. The CIF may also be referred to as a Carrier Indicator Field (CIF). The TTI duration may be indicated by a field that indicates a set of resources such as a set of PRBs, a carrier, a serving cell of the WTRU's configuration, and/or a spectrum block. A TTI duration may be determined from an identity of a PRB subset associated with the transmissions and/or to a time-shifted cell within a subset of PRBs for a concerned carrier frequency. An applicable TTI duration and/or the identity of a slot/period applicable to a transmission within a subframe may be determined using a medium access control (MAC) Activation/Deactivation control element. MAC Activation/Deactivation CE may be used to toggle between first and second TTIs (e.g. legacy TTI and ShTTIs) or between slot-based ShTTIs and/or may be used to determine zero, one or more TTI (e.g. ShTTI) period(s) within a subframe.

HARQ processing may be performed according to a first behavior (e.g. legacy behavior) for one or more (e.g. each) time-shifted cell(s), although there may be exceptions. An exception may be timing-relationships, which may be scaled according to an applicable TTI duration. HARQ A/N feedback formats may use LTE Carrier Aggregation (CA) formats and/or (e.g. legacy) subframe-based timing relationships or a timing relationship associated with the HARQ process. Downlink Control Information (DCI) signaling may use a first (e.g. legacy) format, although, for example, interpretation of fields such as the CIF and/or fields that indicate the PRBs applicable for the transmission may be different than the interpretations of the first (e.g. legacy) format. MAC activation/deactivation signaling may be applicable for time-shifted cells. DRX Timers associated with DRX may scale to HARQ A/N timing according to an applicable TTI duration and/or to the cell associated with an HARQ process. Physical random access channel (PRACH) resources and/or physical downlink control channel (PDCCH) order for RACH may or may not be supported for time-shifted SCells. Timing advance for uplink transmission may be time shifted, for example, according to a shift applied to the TTI associated with a cell. Time shift may be relative to PCell timing, e.g. a PCell may remain a DL timing reference for an SCell with the additional offset corresponding to the start of the ShTTI for those cells.

A method of using a wireless transmit/receive unit within a wireless communications network that is capable of aggregating different sets of physical layer resources (e.g., such as carrier aggregation, for example) may include communicating with a serving cell in the wireless communications network and determining that the serving cell has indicated that the WTRU should use a first transmission time interval on a physical uplink channel to communicate with the serving cell. The method may also include determining whether downlink control information (e.g., a DCI field, DCI message, CIF field, PRB assignment) indicates that the WTRU should use a second transmission time interval that is less than the first transmission time interval to communicate with the wireless communication network (e.g., on the physical uplink channel). The method may further include communicating with the wireless communications network using the second transmission time interval.

The method may include determining that a downlink control information (e.g., a DCI field, DCI message, CIF field, PRB assignment) indicates that the WTRU should use a second transmission time interval that is less than the first transmission time interval to communicate with the wireless communication network (e.g., on the physical uplink channel) comprises determining based on a carrier indicator field in received downlink control information.

The method may include communicating with the wireless communications network using the second transmission time interval comprises communicating with the serving cell using the second transmission time interval.

The method may include wherein communicating with the wireless communications network using the second transmission time interval includes communicating with a secondary cell using the second transmission time interval.

The method may include determining that a downlink control information (e.g., a DCI field, DCI message, CIF field, PRB assignment) indicates that the WTRU should use a third transmission time interval that is less than the first transmission time interval to communicate with a secondary cell in the wireless communications network. The shorten transmission time interval may correspond to at least one of at least one symbol or at least one resource block. The first transmission time interval may be one millisecond.

The method may include determining a time to transmit with the second transmission time interval based on the downlink control information (e.g., a DCI field, DCI message, CIF field, PRB assignment). The time to transmit may defined by a time partition (e.g., a slot in a subframe and/or one or more time symbols, (e.g., OFDM symbols), an arrangement of symbols, a min-slot, or other time for a sub-carrier spacing).

The method may include determining whether a first downlink control information (e.g., using carrier aggregation fields such as the CIF) indicates that the WTRU should use a second transmission time interval that is less than the first transmission time interval to communicate with the wireless communication network (e.g., on the physical uplink channel) or whether the WTRU should transmit using carrier aggregation comprises determining with cross-carrier scheduling.

A wireless transmit/receive unit (WTRU) for use within a wireless communications network that is capable of carrier aggregation may have a processor having executable instructions that communicate with a serving cell in the wireless communications network and determine that the serving cell has indicated that the WTRU should use a first transmission time interval on an uplink channel (e.g., physical uplink channel) to communicate with the serving cell. The processor instructions may include determining whether a downlink control information (e.g., a DCI field, DCI message, CIF field, PRB assignment) indicates that the WTRU should use a second transmission time interval that is less than the first transmission time interval to communicate with the wireless communication network (e.g., on the physical uplink channel). The WTRU processor instructions may include communicating with the wireless communications network using the second transmission time interval.

The WTRU processor instructions that determine that a first downlink control information (e.g, carrier aggregation field such as the CIF) indicates that the WTRU should use a second transmission time interval that is less than the first transmission time interval to communicate with the wireless communication network (e.g., on the physical uplink channel) may comprise determining based on a carrier indicator field in received downlink control information.

The WTRU processor executable instructions that communicate with the wireless communications network using the second transmission time interval may comprise communicating with the serving cell using the second transmission time interval.

The WTRU processor executable instructions that communicate with the wireless communications network using the second transmission time interval may comprise communicating with a secondary cell using the second transmission time interval.

The WTRU processor executable instructions may include determining that a downlink control information (e.g., a DCI field, DCI message, CIF field, PRB assignment) indicates that the WTRU should use a third transmission time interval that is less than the first transmission time interval to communicate with a secondary cell in the wireless communications network. The shorten transmission time interval may correspond to at least one of at least one symbol or at least one resource block. The first transmission time interval may be one millisecond.

The WTRU processor executable instructions may include determining a time to transmit with the second transmission time interval based on the downlink control information (e.g., a DCI field, DCI message, CIF field, PRB assignment). The time to transmit may be defined by a slot in a subframe.

The WTRU processor executable instructions that determine whether a downlink control information (e.g., a DCI field, DCI message, CIF field, PRB assignment) indicates that the WTRU should use a second transmission time interval that is less than the first transmission time interval to communicate with the wireless communication network (e.g., on the physical uplink channel).

### BRIEF DESCRIPTION OF THE DRAWINGS

FIG. 1A is a system diagram of an example communications system in which disclosed subject matter may be implemented.

FIG. 1B is a system diagram of an example wireless transmit/receive unit (WTRU) that may be used in a communications system.

FIG. 1C is a system diagram of an example radio access network and an example core network that may be used in a communications system.

FIG. 1D is a system diagram of an example radio access network and an example core network that may be used in a communications system.

FIG. 1E is a system diagram of an example radio access network and an example core network that may be used in a communications system.

FIG. 2 shows an example of DL physical layer channels.

FIG. 3 shows an example of UL physical layer channels.

FIG. 4 is an example of scheduling with time-shifted cells.

### DETAILED DESCRIPTION

A detailed description of illustrative embodiments will now be described with reference to the various figures. Although this description provides a detailed example of possible implementations, it should be noted that the details are intended to be exemplary and in no way limit the scope of the application.

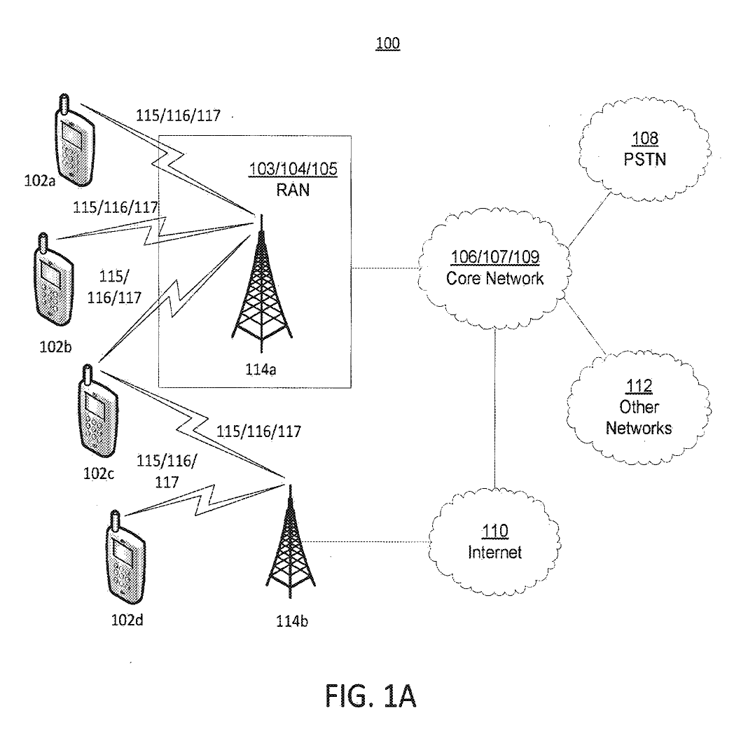

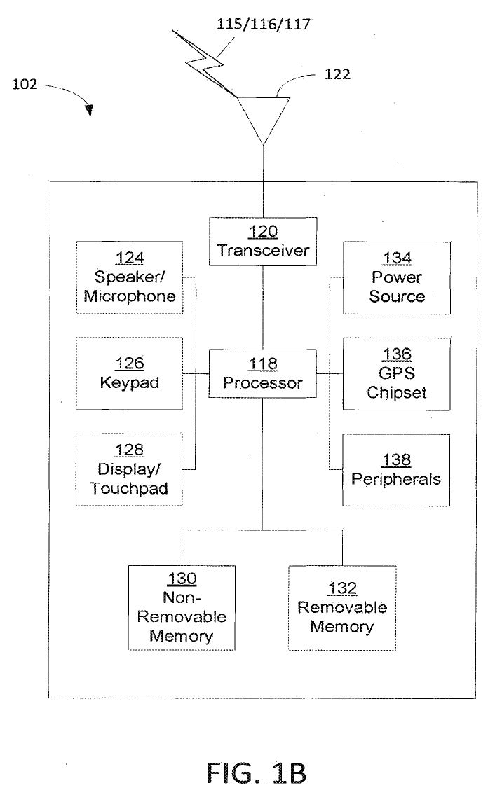

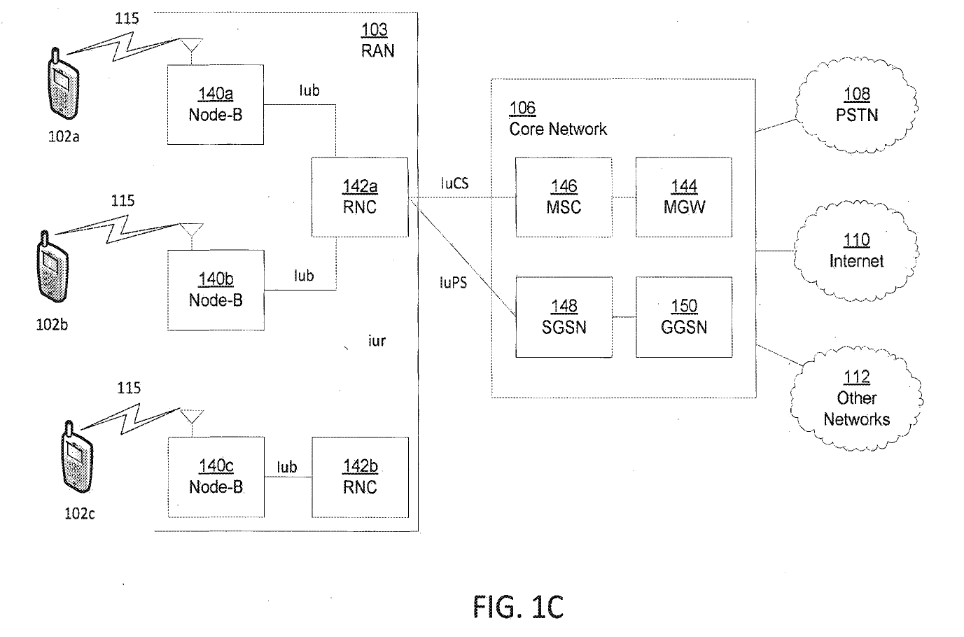

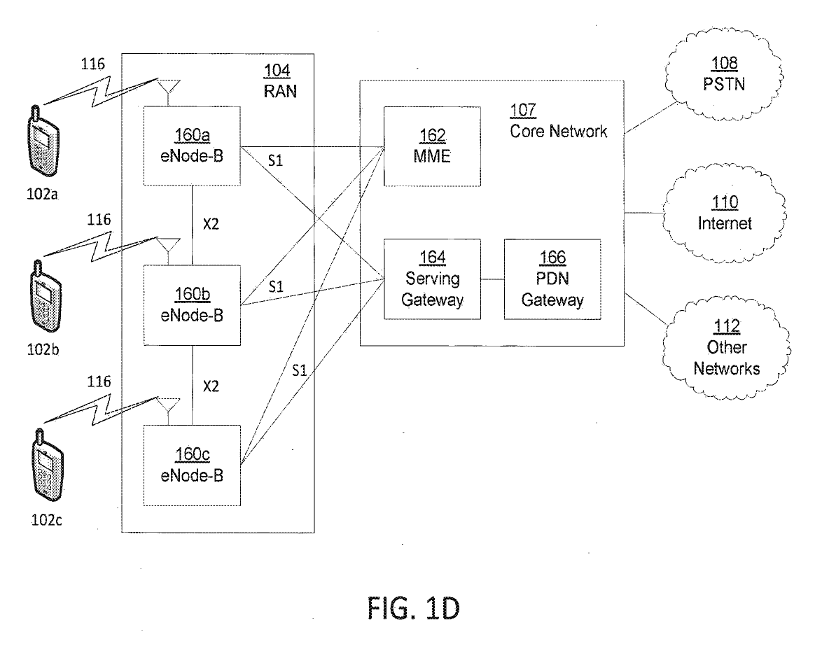

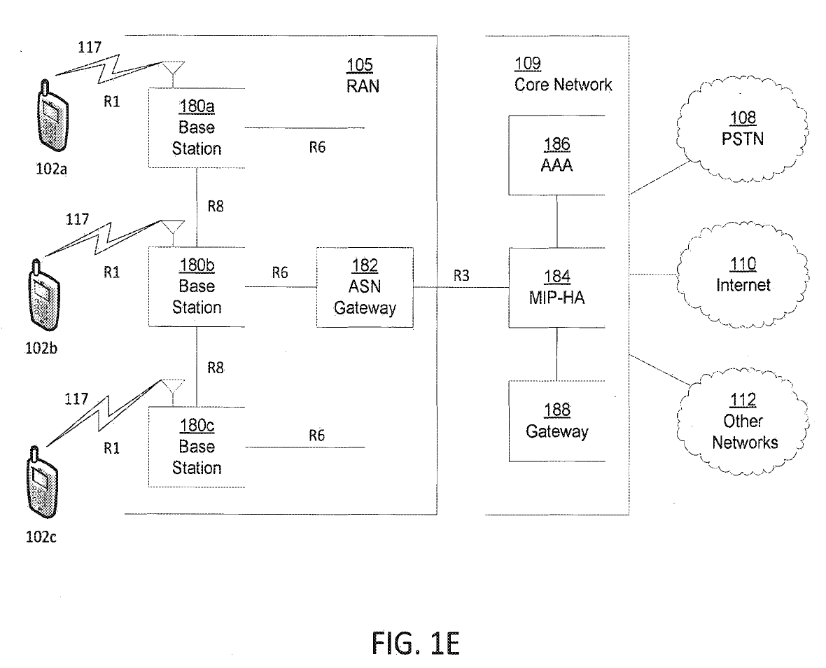

FIG. 1A is a diagram of an example communications system 100 in which one or more disclosed embodiments may be implemented. The communications system 100 may be a multiple access system that provides content, for example voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, for example code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include a user equipment (WTRU), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, for example the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), for example a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g. radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, for example CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In an embodiment, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), New Radio (NR) and the like. The descriptions and example provided herein apply to any of the air interface and communications standards that have been implemented although the terminology may differ among them for the functional components.

The base station 114b in FIG. 1A may be a wireless router, Home Node B, Home eNode B, or access point, for example, and may utilize any suitable RAT for facilitating wireless connectivity in a localized area, for example a place of business, a home, a vehicle, a campus, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet an embodiment, the base station 114b and the WTRUs 102c, 102d may utilize a cellular-based RAT (e.g. WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, for example user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with a RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, for example the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include a core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, for example but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or each of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g. the base station 114a) over the air interface 115/116/117. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g. multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example UTRA and IEEE 802.11, for example.

The processor 118 of the WTRU 102 may be coupled to, and may receive user input data from, the speaker/microphone 124, the keypad 126, and/or the display/touchpad 128 (e.g. a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, for example the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In an embodiment, the processor 118 may access information from, and store data in, memory that is not physically located on the WTRU 102, for example on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g. nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g. longitude and latitude) regarding the current location of the WTRU 102. In addition to, or in lieu of, the information from the GPS chipset 136, the WTRU 102 may receive location information over the air interface 115/116/117 from a base station (e.g. base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, for example outer loop power control, load control, admission control, packet scheduling, handover control, macro diversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, for example the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, for example the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, for example GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, for example anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, for example the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, for example the PSTN 108, to facilitate communications between the WTRUs 102a, 102b, 102c and traditional land-line communications devices. For example, the core network 107 may include, or may communicate with, an IP gateway (e.g. an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, for example handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, for example the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, for example the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Systems, methods, and instrumentalities are disclosed for multiplexing transmissions with different durations, for example such as transmission that utilize different TTI lengths. Latency reduction for some transmissions may achieved, for example, by multiplexing transmissions with different TTI durations. Although examples may be described with respect to multiplexing of an LTE legacy TTI (e.g., 1 ms) with a shortened TTI length (e.g., less than 1 ms), the techniques described herein may be generally applicable to the multiplexing of other types of transmissions that are of different/varying lengths. For example, the examples may be described with respect to transmissions that contain one transport block (TB), but the examples may be equally applicable to transmissions that include a portion of a TB, transmissions that contain multiple TBs, etc. Thus, as may be appreciated, although specific examples herein may be described with respect to multiplexing transmissions associated with a “legacy” 1 ms TTI with transmissions that are less than 1 ms, these examples are not limited to the specific embodiments described and may be applied to transmissions of varying length that include varying amounts of data. Additionally, although examples may be described with respect to multiplexing shorter than 1 ms transmissions into a legacy LTE system that utilizes a legacy TTI length of 1 ms, the techniques may be applied to other types of transmission configurations, for example such as the NR system that may be utilized for 5G cellular communications.

Transmissions of different length may be realized in multiple ways and be consistent with this disclosure. For example, multiple TTI lengths may be defined, and the system may be configured to multiplex transmissions associated with the different TTI lengths over a common set of transmission resources. In example, rather than or in addition to defining different TTI lengths, transmissions of different durations may be supported, for example where one or more of the transmissions durations may or may not correspond to a TTI. Transmission duration may be defined in a number of ways, for example an amount of time over which the transmission occurs, (e.g., a specific duration or a time partition), a number of symbols over which the transmission occurs (e.g., 14 OFDM symbols, 12 OFDM symbols, 1 OFDM symbol, etc.), a slot, a minislot, a time partition for a sub-carrier spacing, and/or in terms of a specific numerology associated with the transmissions. For example, the numerology may be defined based on one or more of a sub-carrier spacing (e.g., different sub-carrier spacing may lead to different time durations for a symbol), a symbol length, a waveform type, etc.

Examples may also be described with respect to one or more cells. However, the techniques described herein may be equally applicable to other types of resource partitions. For example, in LTE cells may be defined based on certain OFDM time-frequency resources that are defined for a certain operating band for the cell. However, the multiplexing techniques described herein may be applied to physical resources that may or may not be defined using the cell construct. For example, the techniques described herein may apply of a subset of the physical resources in a cell and/or to physical resources that are not defined using the cell construct.

In order to TTI duration may be modeled using one or more time-shifted cell(s) for a given carrier frequency, e.g. in an LTE system such as a legacy LTE system. A “logical” cell structure may correspond to an SCell (e.g., a legacy SCell). A PCell may logically maintain a TTI (e.g., a first TTI such as a legacy TTI that may be 1 ms) or may be (e.g. also) configured with a second duration TTI (e.g., a shorter duration TTI (ShTTI) that may be less than 1 ms).

In an example, a WTRU may determine a TTI duration (e.g. first or second TTI) applicable to a transmission. A determination may be, for example, a function of one or more facts, factors, and/or parameters. For example, a WTRU may determine a TTI duration using cross-carrier scheduling information. A WTRU may associate a certain TTI duration with a certain cell identity (e.g. servCellID). A WTRU may associate a certain TTI duration with certain a transmission mode (TM). A TTI duration may be indicated by a CIF included in DCI. For example, a first cell identity (e.g., servCellID=1) may be associated with a first TTI duration and a second cell identity (e.g., servCellID=2) may be associated with a second TTI duration. When the CIF field indicates that the received DCI is applicable to the first cell identity (e.g., CIF=‘001’—servCellID=1), the WTRU may determine that the scheduled transmission is associated with the first TTI duration. When the CIF field indicates that the received DCI is applicable to the second cell identity (e.g., CIF=‘010’—servCellID=2), the WTRU may determine that the scheduled transmission is associated with the second TTI duration. In this matter, carrier aggregation signaling methods may be reused/reinterpreted in order to support multiple TTI length.

A TTI duration may be determined from an identity of a PRB subset associated with the transmissions and/or to a time-shifted cell within a subset of PRBs for a concerned carrier frequency. An applicable TTI duration and/or the identity of a slot/period applicable to a transmission within a subframe may be determined using MAC Activation/Deactivation. MAC Activation/Deactivation may be used to toggle between first and second TTIs (e.g. between a legacy TTI and one or more ShTTIs). For example, a WTRU may utilize a first TTI length for a first cell prior to receiving MAC Activation/Deactivation control element. Upon receiving the MAC Activation/Deactivation control element for the first cell, the WTRU may toggle to a second TTI length. In an example, the MAC Activation/Deactivation control element may be used to toggle between different slots used for a ShTTI transmission in a legacy subframe. For example, the MAC Activation/Deactivation control element may be used to switch between the first and second slots for the shortened TTI transmission. MAC Activation/Deactivation may be used to determine zero, one or more ShTTIs period(s) within a subframe.

HARQ processing may remain according to a first behavior (e.g. legacy behavior) for one or more (e.g. each) time-shifted cell(s), although there may be exceptions. In an example, an exception may be timing-relationships, which may be scaled according to an applicable TTI duration. HARQ A/N feedback formats may use LTE Carrier Aggregation (CA) formats and/or (e.g., legacy) subframe-based timing relationships or a timing relationship associated with the HARQ process. Downlink Control Information (DCI) signaling may use a first (e.g., legacy) format, although, for example, interpretation of fields such as the CIF and/or PRBs applicable for the transmission may be different than the first (e.g., legacy) format. MAC activation/deactivation signaling may be applicable for time-shifted cells. DRX Timers associated with DRX may scale to HARQ A/N timing according to an applicable TTI duration and/or to the cell associated with an HARQ process. PRACH resources and/or PDCCH order for RACH may or may not be supported for time-shifted SCells. Timing advance for uplink transmission may be time shifted, for example, according to a shift applied to the TTI associated with a cell. Time shift may be relative to PCell timing, e.g., a PCell may remain a DL timing reference for an SCell with the additional offset corresponding to the start of the ShTTI for those cells.

A device may access resources of a communication system. Latency associated with transmission of data may have one or more latency components. A latency component may be the time to perform the transmission of a transport block, which time may be referred to as a Transmission Time Interval (TTI). A latency component may be processing time at a receiver, e.g., time decoding a transmission. Receiver processing time may be tied to implementation complexity and may be accounted for using a fixed timing relationship between different events associated with the transmission of a data unit. A timing relationship may be fixed, for example, when time-division duplex (TDD) is used for a carrier and/or synchronous Hybrid ARQ (HARQ) operation (e.g., such as for LTE in the uplink).

There may be additional latency components, for example, when a transmission is not successfully decoded. For example, additional components may include transmission of feedback (e.g. HARQ ACK or NACK), processing time at the receiver and/or one or more retransmissions with one or more latency components.

Latency components may be measured in integer multiples of a basic time interval (BTI). For example, latency components may be measured in TTIs, e.g., in LTE.

Latency in wireless networks may be caused by multiple factors. Latency may be affected, e.g., at lower layers, by a need for highly reliable transmissions, which may be obtained using HARQ. One or more retransmissions may affect the latency of a transmission, for example, given that retransmissions may not be performed in adjacent time periods.

A WTRU may incur processing time, for example, for downlink (DL) transmission, to determine whether a transmission was decoded properly, which may lead to a time interval between reception of a DL transmission and transmission of an ACK or NACK. An eNB may incur processing time, for example, to determine whether an ACK or NACK was transmitted by the WTRU and/or whether a retransmission is required. A similar consumption of processing time may occur for uplink (UL) transmissions. Processing times may be cumulative. There may be a tradeoff between latency and implementation complexity.

A system (e.g. LTE) may accommodate processing times in a timing relationship between a first transmission for a transport block and its corresponding ACK-NACK HARQ response for downlink and/or uplink operation and possible retransmission.

Time Division Duplex (TDD) and Frequency Division Duplex (FDD) DL scheduling timing may be the same, such that a WTRU may receive a scheduling grant for a DL transmission in the same subframe or transmission time interval (TTI).

A WTRU may transmit a corresponding Physical UL Shared Channel (PUSCH), e.g., in subframe n+4, for example, upon detection of a Physical DL Control Channel PDCCH or enhanced PDCCH (EPDCCH) with UL Downlink Control Information (DCI) format and/or Physical Hybrid ARQ Indicator Channel (PHICH) transmission in subframe n, e.g., in an FDD UL transmission intended for the WTRU. A HARQ ACK/NACK response for a DL or UL transmission in subframe n may be provided in subframe n+4.

A WTRU may transmit a corresponding PUSCH in subframe n+k, for example, upon detection of a (E)PDCCH with UL DCI format and/or PHICH transmission in subframe n, e.g., for a UL transmission in a TDD system intended for the WTRU. The value of k may depend on the TDD UL/DL configuration, the subframe where the UL DCI and/or PHICH was transmitted and/or the PHICH resource and the MSB or LSB of the UL index in the (E)PDCCH, e.g., in TDD UL/DL configuration 0. A HARQ ACK/NACK response for a DL or UL transmission in subframe n may be provided in subframe n+k, where k may depend on the value of n and the TDD UL/DL configuration. Bundling may be used to provide HARQ for multiple transmissions in one instance.

Processing time available to a WTRU may depend, for example, on the value of the timing advance or on the distance between the WTRU and the eNB. In an example, an LTE system may have a distance of 100 km between a WTRU and an eNB, which may correspond to a (e.g. a maximum) timing advance of 0.67 ms. In an example, there may be approximately 2.3 ms left for terminal processing. An eNB may have, for example, 3 ms processing time available, which may be on the same order as that of the terminal.

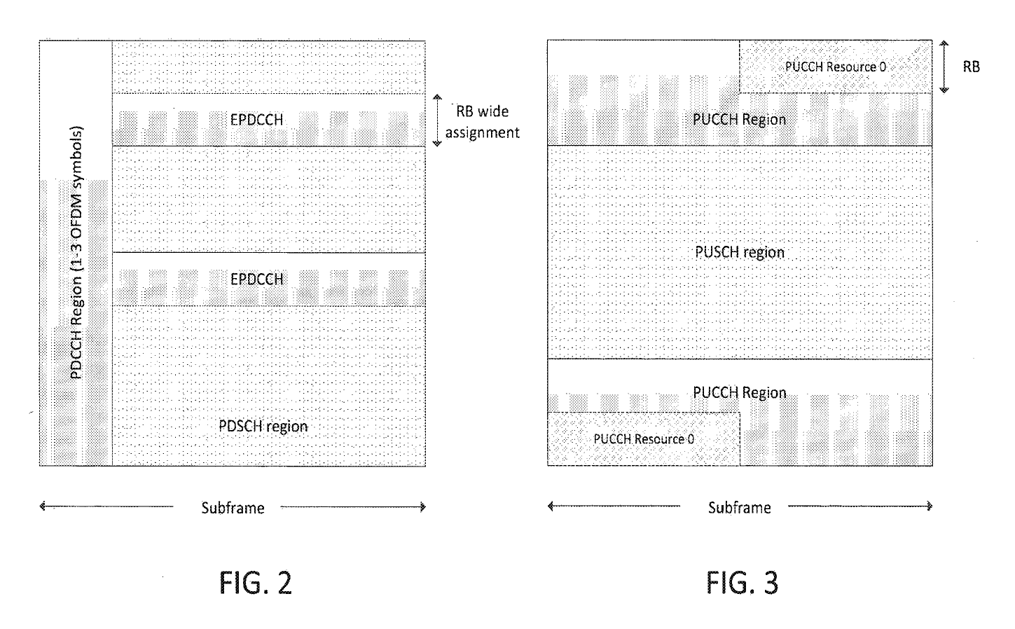

FIG. 2 shows an example of DL physical layer channels. In a DL example with reference to the example shown in FIG. 2, there may be three channel areas in a subframe to support DL Shared Channel (DL-SCH) and UL-SCH. Three channel areas may comprise a PDCCH (which may include Physical Control Format Indicator Channel (PCFICH) and PHICH), a Physical DL Shared Channel (PDSCH) and an EPDCCH. An EPDCCH may include scheduling information for a WTRU while taking advantage of the benefits of the PDSCH region, such as beamforming gain and frequency domain Inter-Cell Interference Coordination (ICIC) and/or improving PDCCH capacity.

FIG. 3 shows an example of UL physical layer channels. In a UL example with reference to the example shown in FIG. 3, there may be two channel areas in a subframe to support DL-SCH and UL-SCH. Two channel areas may comprise a PUSCH and a PDSCH. These channel areas may be transmitted in different RBs in each time slot (e.g. frequency hopping of PUSCH), for example, to increase robustness in frequency selective channels.

A transmission time interval (TTI) duration may be based on and/or defined by one or more symbols. A TTI duration may be defined in terms of a number of OFDM symbols. For example, a TTI duration may be defined as an entire (legacy) subframe and/or a pair of physical resource blocks (PRBs). In the legacy 1 ms TTI length, there may be 14 OFDM symbols for normal cyclic prefix and 12 OFDM symbols for extended cyclic prefix. For example when multiplexing ShTTI transmissions with legacy TTI transmissions of 1 ms, a ShTTI may be made as short as a single ODFM symbol. Symbol-based categorization may be referred to as symbol-based TTI durations.

A TTI duration may be based on time-varying symbol duration. TTI durations may have a fixed number of symbols (e.g., 14 symbols) while symbol duration may vary in time. For example, variable time symbol-based TTI duration may be achieved by modifying subcarrier spacing. In an example, a first TTI duration may be achieved with a first subcarrier spacing and a second TTI duration may be achieved with a second subcarrier spacing. Different bandwidth portions (e.g. PRBs) of a carrier may support different subcarrier spacing, thus enabling different TTI duration for different bandwidth portions (e.g. PRBs). Multiplexing transmissions associated with different sub-carrier spacing and/or symbol duration may be applicable to 5G systems such as NR. Such techniques may also be used in LTE-Advanced.

A TTI duration may be based on a time slot. A TTI duration may be defined in terms of a time slot (e.g. 7 OFDM symbols for normal cyclic prefix and 6 OFDM symbols for extended cyclic prefix). For example, if a ShTTI is defined as the length of one slot, two ShTTI transmissions may be time multiplexed into a legacy 1 ms TTI length.

A TTI duration may be based on time. A TTI duration may be defined in terms of a time value (e.g. 1 ms legacy TTI or a 100 ms ShTTI).

A TTI duration may be based on a hybrid, such as a combination of forgoing TTI duration bases. In an example of a hybrid method of achieving variable TTI durations, a different number of symbols and different symbol durations may be used.

Latency may be improved. It may be beneficial to decrease the TTI duration of different channels. A decrease in TTI duration may enable a decrease in WTRU processing time and may permit a WTRU to begin processing data sooner. Such a scenario may enable a shorter HARQ timeline. Different channels may have different TTI durations. A TTI duration shorter than one subframe for one or more of the EPDCCH, PDSCH, PUCCH, PDSCH, etc. may be provided. Effective HARQ feedback for PDSCH and PUSCH transmissions using shorter than (e.g., legacy 1 ms) subframe TTI durations may be provided. Shorter TTIs may be referred to as ShTTI.

ShTTI and/or a combination of TTI and ShTTI may be supported for a given WTRU, for example, to minimize the impact of other aspects related to WTRU transmissions, such as scheduling (e.g., formats of DCIs), HARQ (e.g., related processing/process identities), feedback formats and determination of an applicable TTI duration. For example, the configuration of ShTTIs and/or the signaling of DCI for ShTTIs may utilize certain signaling originally defined for purposes of carrier aggregation in order to limit the amount of complexity at the WTRU and/or facilitated TTI length multiplexing in a backwards compatible manner. One or more latency components may be reduced, for example, to minimize the impact on WTRU implementations.

A WTRU may (e.g., based on a determination) operate with a one or more TTI durations, such as subframe TTI duration (e.g., 1 ms), a timeslot TTI duration (e.g., 0.5 ms), a symbol-based TTI duration (e.g., one or more OFDM symbols in duration), and/or other shorter than 1 ms TTI durations. In an example, a WTRU may be configured to operate with specific but different TTI duration configuration in downlink and uplink. In an example, a WTRU may be configured to permit the same TTI duration configuration to be used in downlink and uplink for applicable transmissions. For example, if the WTRU receives a configuration that indicates a first cell is associated with a first TTI duration in the downlink, the WTRU may determine that the uplink TTI duration is also the first TTI duration unless the configuration indicates otherwise.

A TTI duration may be WTRU specific. A WTRU may operate with a TTI duration during a given period. A WTRU may be configured to operate according to one or more of a plurality of possible TTI durations and may operate with the one or more TTI durations for a specific period of time, e.g., based on an L3 (e.g., radio resource control (RRC)) reconfiguration. A TTI duration may be fixed (e.g. statically, semi-statically or dynamically) for a (e.g. every) transmission to and from a WTRU.

Multiple TTI durations may be concurrently configured and/or used. A WTRU may be configured to operate for transmissions of different TTI durations concurrently. Different TTI durations may be based on, for example, semi-static allocation (e.g. configuration of a subset of frames/subframes dedicated to different TTI durations based on a semi-persistent grant or assignment) and/or dynamic allocation (e.g. based on detection and/or reception of downlink control signaling).

A TTI duration may be cell/cell group (CG)-specific. Configuration may be applicable per cell of a WTRU's configuration, for a subset of cells of a WTRU's configuration, and/or for all cells of the same timing advance group (TAG) and/or all cells of the same cell group (CG). For example, upon adding a new cell, the TTI duration may be defined for the new cell. As an example, if the WTRU adds an SCell, the SCell configuration may indicated that the WTRU is to utilize a shortened TTI duration for the SCell. The HARQ instances associated with a specific MAC entity may be configured with a similar configuration for TTI duration. A similar or same configuration for TTI duration may be used, for example, for cells associated with the same channel(s) (e.g. PUCCH, PUSCH) for uplink control signaling.

TTI duration may be modeled using one or more time-shifted cell(s) for a given carrier frequency. Modeling may enable co-existence between WTRUs operating according to different TTI durations, e.g. in legacy LTE systems. A “logical” cell structure may correspond to the use of one or more serving cell(s). Serving cells may include secondary cells, such as an SCell type or a PSCell type defined for LTE CA. A PCell may logically maintain a first (e.g., legacy) TTI such as 1 ms or may be (e.g., also) configured as a ShTTI.

Multiple serving cells may be associated with a specific TTI duration. A WTRU may support multiple TTI durations based on one or more functions and/or characteristic associated to a serving cell.

A WTRU may determine the duration of a downlink control region, e.g., according to a first (e.g., legacy) behavior for LTE. A reception of PDCCH may be a first (e.g., legacy) behavior for downlink subframes. In an example, the first ShTTI in a subframe may include a control region, e.g., in case of slot-based operation, such as two slots of 7 symbols where the first slot include 1-3 symbols for PDCCH. In an example, the ShTTI duration may exclude the control region, e.g., in case of symbol-based ShTTIs. In an example, an offset in time or in symbol from the start of a subframe may be used to indicate the start of an ShTTI (e.g., in the DCI).

In an example, a WTRU may operate on a given carrier frequency (e.g., for downlink and/or uplink) according to at least one of the following: TTI duration per Transmission Mode (TM), TTI duration per Serving Cell Identity (servCellID), and/or TTI duration per Serving Cell.

In an example of TTI duration per Transmission Mode (TM), a WTRU may be configured with multiple transmission modes (TM), e.g., one for each applicable TTI duration.

In an example of TTI duration per Serving Cell Identity (servCellID), a WTRU may be configured with multiple serving cell identities (e.g., servCellIDs), e.g., one for each applicable TTI duration.

In an example of TTI duration per Serving Cell, a WTRU may be configured with multiple serving cells for a given carrier frequency, e.g. one for each applicable TTI duration.

Combinations may be made using different types of serving cells. For example, a WTRU may be configured according to any of the following examples or other examples.

In a first case or example, a WTRU may be configured with one PCell and one SCell (or PSCell). A WTRU may perform a transmission associated with a PCell using a first ShTTI and a transmission associated with the SCell/PSCell using a second ShTTI. A WTRU may transmit Uplink Control Information (UCI) for a transmission associated with a specific cell using the uplink resources associated with the concerned cell (e.g., according to a first (e.g. legacy) behavior or processing time associated with the ShTTI), for example, when an SCell is configured with PUCCH resources or when the WTRU is configured with PSCell. A WTRU may perform the transmission of UCI using resources of the PCell (e.g., according to a first (e.g., legacy) behavior), for example, otherwise. In either case or other cases, a WTRU may transmit UCI using the TTI applicable to the uplink configuration of the concerned cell or according to the ShTTI applicable the received transmission.

In a second case or example, a WTRU may be configured with one PCell and two SCells. A WTRU may perform a transmissions associated with a PCell using a first TTI (e.g., a legacy 1 ms TTI) and a transmission associated with an SCell using a second TTI (e.g., an ShTTI). A WTRU may transmit UCI for a transmission associated with a specific cell using the uplink resources associated with the concerned cell (e.g., according to a first (e.g., legacy) behavior or processing time associated with the ShTTI), for example, when an SCell is configured with PUCCH resources. A WTRU may perform the transmission of UCI using resources of the PCell (e.g., according to a first (e.g., legacy) behavior), for example, otherwise. In either case or other cases, a WTRU may transmit UCI using the TTI applicable to the uplink configuration of the concerned cell or according to the ShTTI applicable to the received transmission.

In a third case or example, a WTRU may be configured with one PCell and multiple SCells. A configuration may be a generalization of either of the first and second examples, whereby more than two TTI durations may be supported (e.g., within a first (e.g., legacy) subframe).

In an example involving a PSCell, a different Cell Radio Network Temporary Identifier (C-RNTI) than that applicable for a PCell may indicate the duration of the TTI. Examples presented and other examples may be used separately or in combination. Other realizations and/or combinations are possible.

Examples for handling of downlink control region for case 1 with slot-based operation are described.

A WTRU may be configured with a (e.g., DL) control region of zero symbols for a serving cell used for the purpose of ShTTI, e.g., for the serving cell that corresponds to a second slot in case of slot-based operation. A WTRU may determine that a serving cell is configured for the purpose of ShTTI, for example, based on reception of signaling that indicates such value for the duration of the control region. A WTRU may determine that a serving cell is configured as an ShTTI for the second slot, for example, based on reception of signaling that indicates such value for the duration of the control region. A WTRU may determine that a PCell configuration is used for ShTTI for the first slot.

Different procedures or algorithms may be used to determine applicable TTI duration, e.g., independent of modeling. For example, a WTRU may determine the TTI duration (e.g. legacy duration such as 1 ms or shorter (e.g., ShTTI)) applicable to a transmission as a function of one or more of the following: (a) a WTRU may determine TTI duration using cross-carrier scheduling; (b) a WTRU may associate a TTI duration with a serving cell identity; (c) a TTI duration may be indicated by a Carrier Indicator Field (CIF); (d) a TTI duration may be indicated by C-RNTI applicable to control signaling associated with the allocation of resources; (e) a TTI duration may be determined from the identity of a PRB subset applicable to the transmissions and/or to the time-shifted cell within the entire subset of PRBs for the carrier frequency; (f) a MAC Activation/Deactivation may be used to determine the applicable TTI duration and/or the identity of the slot/period applicable to a transmission within a subframe. A MAC Activation/Deactivation may be used, for example, to toggle between multiple TTIs (e.g. a legacy TTI and one or more ShTTIs), toggle between slot-based ShTTIs and/or to determine zero, one or more ShTTIs period(s) within a subframe.

HARQ processing may be used (e.g., according to a first (e.g., legacy) behavior) for time-shifted cell(s), although, in an example, timing-relationships may be scaled according to an applicable TTI duration. HARQ A/N feedback formats may reuse LTE CA formats, first (e.g., legacy) subframe-based timing relationships and/or timing relationship associated with the HARQ process. DCI signaling may reuse a first (e.g., legacy) format, although, in an example, interpretation of fields such as the CIF and/or PRBs applicable for the transmission may be different. MAC activation/deactivation signaling may be applicable for time-shifted cells. DRX Timers associated with DRX may scale to HARQ A/N timing according to an applicable TTI duration and/or to the cell associated with the HARQ process. Physical Random Access Channel (PRACH) resources and/or PDCCH order for RACH may or may not be supported for time-shifted SCells. Timing advance for uplink transmission may be time shifted according to the shift applied to the TTI associated with a cell, for example, when such time shift is relative to the PCell timing (e.g., the PCell remains the DL timing reference for such SCell with the additional offset corresponding to the start of the ShTTI for those cells).

Any procedure or algorithm that may operate with or indicate a TTI duration may be applicable as a procedure or algorithm to operate with or to indicate a subcarrier spacing.

Support may be provided for transmissions with different TTI duration. A WTRU may be configured for operation with the LTE physical layer. A WTRU may be configured, for example, for operation according to a first (e.g., legacy) LTE behavior or for operation together with a 5gFLEX configuration, e.g., a configuration that supports a physical layer operating with other variants of potentially filtered OFDM transmissions, such as Universal Filtered OFDM (UF-OFDM), Filtered Based OFDM (FB-OFDM), etc.

In an example of LTE FDD, a radio frame may consist of 10 subframes of 1 ms each with a TTI of 1 ms. Each TTI may consist of two 0.5 ms slots of 7 symbols for a configuration with a normal cyclic prefix. In the downlink, there may be 8 asynchronous HARQ processes numbered 0-7 that may be addressed by means of downlink DCI. In the uplink, there may be 8 synchronous HARQ processes per RTT, which identity may be tied to the subframe timing. A WTRU may be configured for 1 to 3 symbols at the beginning of the first slot used for control signaling (PDCCH). Control signaling may span the entire bandwidth for a given cell. A TTI duration may be fixed, e.g., at 1 ms, as an aspect of the LTE physical layer.

Different cells of a WTRU's configuration may be (e.g. explicitly) associated with a TTI duration/offset shift. Support for different TTI durations may be realized, for example, by maintaining a unique association between a cell and a TTI duration in a WTRU's configuration. Timing associated with the cell (e.g. a cell of the LTE CA SCell type) may be shifted and/or offset in time with respect to the timing of a reference cell. A reference cell may be the PCell of the WTRU's configuration. The PCell may be considered to have a zero time shift, e.g., by default. In an example of dual connectivity, a PSCell may be considered to have a zero time shift (e.g., by default), for example, when a secondary group of cells is configured and when the PSCell is used as the timing reference.

In an example, a time-shifted/TTI duration/offset shift may be associated with an identity. For example, a time-shifted cell may be configured with a serving cell identity, with an offset in time relative to the start of a cell-specific subframe (e.g. where timing may be based on the PCell used as a downlink timing reference) and with a TTI duration (e.g. shorter than a first (e.g. legacy) timing that may be referred to as a shorter TTI or ShTTI).

TTI duration may be a configuration aspect of a WTRU, such as part of a configured transmission mode associated with the physical layer configuration for the cell.

Cells using a timing relationship may be configured as part of the same timing advance group (TAG). Cells (e.g., SCells) in a secondary TAG (STAG) supporting ShTTIs may use one of the cells in the same TAG as a timing reference (e.g., a cell used may be a configuration aspect of a WTRU) or may use the PCell as the timing reference (e.g., otherwise).

Support may be provided for multiplexing transmissions in a cell and/or for a specific WTRU. Support for transmissions using different TTI duration may be for concurrent transmissions in the same cell. For example, transmission may correspond to a single TTI duration for each WTRU at any given time while some WTRUs may have different TTI duration than other WTRUs. Support may be for transmissions for a given WTRU within the same subframe (e.g., within a first (e.g., legacy) subframe such as 1 ms) where different transmissions may be performed according to different TTI durations by the concerned WTRU.

Procedures may be applicable for uplink and/or downlink transmission and may be a configuration aspect for a WTRU.

An ShTTI-based transmission mode (TM) and cell timing configuration may be provided. For example, a WTRU may be configured with a PCell (e.g., according to first (e.g., legacy) behavior). For example, a WTRU may operate on a PCell carrier frequency using a first TM (e.g., a TM in the range of 1-10) associated with a first TTI duration (e.g., legacy 1 ms). The WTRU may receive a RRC Connection Reconfiguration message that may reconfigure the WTRU according to at least one of the following: the WTRU may reconfigure the PCell and/or may configure at least one SCell.

In an example of reconfiguring a PCell, the WTRU may reconfigure the PCell such that a second TTI (e.g., ShTTI) of a duration shorter than previously used by the WTRU for the PCell is supported. For example, the WTRU may reconfigure (or add) a TM associated to the PCell. For example, a TM (e.g., TM=11) may be associated with a TTI duration different than previously used by the WTRU for the PCell.

For example, a WTRU may configure a TTI duration according to one of the following. In an example, an ShTTI duration may be equal to 1 slot (0.5 ms). This may be applicable, for example, to the first case. In another example, an ShTTI may be a duration expressed as an integer multiple of 1 symbol. A duration may include the control region, for example, when the configuration includes a start offset for the ShTTI and such offset is equal to zero. In another example, an ShTTI may be a duration expressed as an integer value in time, e.g. 100 μs or 125 μs. Whether an ShTTI duration may include the control region may be determined as a function the value of a start offset for the ShTTI when applicable. A control region may be a separate aspect of a WTRU's configuration for a cell when an offset is equal to a non-zero value.

For example, a TM may support transmissions in (e.g., only in) the first slot of a first (e.g., legacy) subframe for the concerned ShTTI duration. A WTRU may determine an aspect as a function of the type of cell (e.g., PCell) associated with the TM. A TM may support WTRU-specific demodulation reference signals (e.g., DM-RS) such that their location and density may be better suited for ShTTI operation.

In an example of reconfiguring a PCell, transmissions on the PCell using a first (e.g., legacy) TTI such as 1 ms may be enabled. This may be applicable, for example, in the second case, e.g., when a WTRU may be configured such that PCell operation supports transmissions using a first (e.g. legacy) 1 ms TTI and one or more SCells support operation using ShTTI.

A WTRU may configure a PCell with an additional cell identity to the PCell in the PCell's configuration such that DCI may indicate, for example, “CIF=0” for a transmission on PCell using a first TTI (e.g., 1 ms) and “CIF=1” for a transmission on PCell using a second TTI (e.g. a slot-based ShTTI of 0.5 ms or similar). This may be applicable, for example, in the first case.

In an example of reconfiguring at least one SCell, the WTRU may configure an SCell such that an associated TTI duration (e.g., ShTTI) is less than that of a first (e.g., legacy) subframe duration (e.g., less than 1 ms). For example, the WTRU may configure a TM associated with the SCell. For example, a TM (e.g., TM=11) may be associated with a TTI duration similar to that of the PCell (e.g., ShTTI). For example, a ShTTI duration may be equal to 1 slot (0.5 ms). This may be applicable, for example, in the first case. A TM (e.g., TM=11+x) may be (e.g. alternatively) associated with a TTI duration different than that of the PCell, for example, when the TTI duration of such SCell may differ from that of the PCell.

Combinations of slot-based TTI (e.g., 0.5 ms for a PCell) and non slot-based TTIs (e.g., 5 SCells of 100 ms each) may be applicable for a given WTRU. Another example may be of a WTRU configured with symbol-based TTIs such that a different number of symbols may be used for each of the control regions (e.g,. 3 symbols), the TTI duration for the PCell (e.g., 5 symbols) and for a number of SCells of x symbols in duration (e.g., 3 SCells each 2 symbols in TTI duration). Other combinations and/or other values are possible.

Example procedures may be applicable to any of the cases described above. Procedures may be applicable for uplink and/or downlink transmission and may be a configuration aspect for a WTRU.

TTI duration may be determined as a function of a Carrier Indicator Field (CIF) in a DCI on PDCCH. A TTI duration may be signaled as a function of the indicated cell identity in the DCI (e.g., by CIF or similar for a given carrier frequency of the WTRU's configuration). A determination or indication may be achieved, for example, by associating a second identity with a cell of the WTRU's configuration or by duplication of a serving cell configuration for a given carrier frequency. The WTRU may determine that the DCI of a given transmission (e.g., PDDCH transmission, serving cell transmission, received downlink control information, or scheduling information) has indicated that the WTRU should use a first transmission time interval on a physical uplink channel to communicate with the serving cell. For example, the determination may be based on the CIF field of the DCI, as the CIF may refer to a serving cell identity that has been configured to utilize the first transmission time interval. In this manner, downlink control information (e.g., a DCI field, DCI message, CIF field, PRB assignment) may be re-used for scheduling of transmissions associated with the first TTI length. Similarly, the WTRU may determine that the DCI of a given transmission (e.g., PDDCH transmission, serving cell transmission, received downlink control information, or scheduling information) has indicated that the WTRU should use a second transmission time interval on a physical uplink channel to communicate with a second serving cell. For example, the determination may be based on the CIF field of the DCI, as the CIF may refer to the second serving cell identity and the second serving cell may have been configured to utilize the second transmission time interval. One or more of the first or second transmission time intervals may correspond a shortened TTI that is less than the legacy transmission time interval. The first and second serving cells may configured to utilize the same frequency band and/or carrier frequency.

In an example using slot-based TTI duration, a WTRU may be configured with a PCell with CIF=0, an SCell with CIF=1 and an SCell with CIF=2 for a given carrier frequency. Both SCells may be configured with carrier aggregation cross-carrier scheduling such that scheduling information for the associated resources may be received on the PDCCH associated with the PCell. A WTRU may receive signaling that schedules a transmission on such PDCCH. A WTRU may determine that a TTI duration is according to first (e.g., legacy) operation (e.g., 1 ms), for example, when the WTRU determines that the CIF applicable to the transmission is that of the PCell. The WTRU may determine that the transmission is applicable to the first slot of the concerned subframe, for example, when the WTRU determines that the CIF=1. The WTRU may determine that the transmission is for the second slot of the concerned subframe, for example, when CIF=2.

Example procedures may be applicable to any of the cases described above. Procedures may be applicable for uplink and/or downlink transmission and may be a configuration aspect for a WTRU.

A start offset for ShTTI may be a function of CIF in the DCI on PDCCH. In an example, determination of the applicable location in time (e.g., slot in the subframe, applicable starting symbol and/or all applicable symbols or similar) may be enabled for a transmission, for example, when a TTI duration shorter than that of the subframe duration is configured for a given cell.

A start offset or applicable location in time may be based on signaling received by the WTRU. The WTRU may perform such determination as a function of the indicated cell identity in the DCI, e.g., by Carrier Indicator Field (CIF) or similar for a given carrier frequency of the WTRU's configuration. An indication or determination may be achieved, for example, by associating a specific offset in the subframe with an identity of a cell of the WTRU's configuration or by configuring multiple serving cells for a given carrier frequency each with a different identity and a different offset.

For example, an offset may indicate one of a first slot or a second slot of a cell-specific subframe or it may indicate an offset in terms of a starting symbol in a subframe or an offset in absolute time (e.g. 500 ms). An offset may be applied from the start of a cell-specific subframe. An offset may implicitly indicate a TTI duration (or vice-versa).

Example procedures may be applicable to any of the cases described above. Procedures may be applicable for uplink and/or downlink transmission and may be a configuration aspect for a WTRU.

A TTI duration may be a function of PRB(s) for a transmission. In an example, a WTRU may be configured such that a number of PRBs (e.g. a subset of the total set of system-specific PRBs for the concerned carrier frequency) may be associated with a cell of the WTRU's configuration for which the WTRU is operating with shorter than 1 ms TTI duration e.g. configured with ShTTI.

A WTRU may determine an applicable TTI duration as a function of the PRB(s) indicated by the scheduling information. A PRB may correspond to the starting PRB for the resource allocation for the transmission. A set of PRBs may correspond to a range of PRBs. A WTRU may use the TTI duration associated with a set of PRB(s), for example, when such range includes (e.g., only includes) PRB(s) associated with the concerned set. A WTRU may (e.g., otherwise) use a different TTI duration (e.g., a first (e.g. legacy) TTI duration, such as 1 ms, or a configured duration), for example, when such range includes PRBs associated with different sets of PRBs or when such range does not include PRBs associated with any such sets. Sets of PRBs may be a configuration aspect of a WTRU's configuration. For example, a serving cell may be associated with a set of one or more PRBs, for example, when a serving cell is configured for ShTTI operation for a carrier frequency. A WTRU may use the TTI duration associated with such a cell or associated with the concerned PRBs. Scheduling information may be received dynamically in a DCI on PDCCH. Scheduling information may be semi-statically configured. For example, an entire (e.g., system-specific) set of PRBs for a PCell configured with a first (e.g., legacy) operation may be 110 PRBs. A WTRU may (e.g., alternatively) be configured with one or more subsets of PRBs, where each set may be associated with a specific TTI duration.

A WTRU may (e.g., first) determine the cell configured with ShTTI applicable to the transmission and/or the duration of the TTI (e.g., determining as described herein) and may determine the set of applicable PRBs therefrom (e.g., determining using a configuration of sets of PRBs as discussed herein).

Example procedures (e.g., operation) may be applicable to any of the cases described above. Procedures may be applicable for uplink and/or downlink transmission and may be a configuration aspect for a WTRU. For example, a procedure may be associated with a transmission mode for downlink and/or uplink. For example, a procedure may be associated with a serving cell of the WTRU's configuration. For example, a WTRU may determine that a configuration is specific to a serving cell of a WTRU's configuration, e.g., a determination may be made that a TTI configuration applies to both DL and UL frequencies. For example, a WTRU may determine that a configuration is specific to a specific direction of a configuration for a given serving cell of the WTRU's configuration, e.g., a determination may be made that a TTI configuration is provided separately for the DL direction and for the UL direction.

A determination may be made about the start offset time for a transmission. Cell de-activation may control availability of ShTTI. In an example, a first (e.g., legacy) cell activation-deactivation mechanism (e.g., procedure or algorithm) may control the duration (e.g., first or second TTI such as a legacy TTI or an ShTTI duration) of a transmission, e.g., by activating and deactivating the transmission. A WTRU may associate an activation state with an ShTTI, a slot and/or a resource.

In an example, a WTRU configured using ShTTI cells may receive a first (e.g., legacy) MAC activation/deactivation control element. A WTRU may use the activation/deactivation element as a mechanism to determine the availability of the ShTTI. For example, a WTRU may use a first (e.g., 1 ms) TTI duration, e.g., when the WTRU is configured with a single SCell with ShTTI and when the SCell is in a deactivated state when the WTRU determines that it needs to perform a transmission. A WTRU may (e.g., otherwise) use a second TTI duration (e.g., ShTTI) for a transmission, e.g., when the SCell is active. The WTRU may perform a transmission using the second TTI duration (e.g. ShTTI), for example, according to scheduling information independently of the scheduled slot. This example may be extended to apply to the case where a symbol-based TTI duration is used instead of a time duration such as transmission slots.

In an example where multiple SCells may be used to indicate slot-based transmissions, a WTRU may determine that a first TTI duration is applicable when all cells configured with ShTTI are in a deactivated state. A WTRU may determine (e.g., otherwise) the applicable slot based on the activation state associated with each SCell and associated with each slot. This example may be extended to apply to the case where a symbol-based TTI duration is used, e.g., instead of using time duration such as transmission slots.

A WTRU may transmit HARQ feedback and/or other Uplink Control Information (UCI) (e.g. CQI, PMI, RI or similar), for example, taking into consideration the configuration of the TTI duration.

A TTI duration applicable to the transmission of UCI may be a function of at least one of the following: scheduling information, configuration information, TTI applicable to a serving cell, a default configuration for UCI transmission, etc.

Scheduling information may indicate whether a WTRU has resources for a PUSCH transmission and (e.g., if so) the TTI duration associated with such transmission, which may be determined according to procedures described herein.

Configuration information may indicate whether a WTRU is configured for simultaneous PUSCH and PUCCH transmission.

A TTI may be applicable to a serving cell associated with a UCI transmission in the subframe for the concerned UCI transmission.

A TTI may be applicable (e.g., in duration and/or offset) to a serving cell associated with a UCI transmission in the subframe for a downlink transmission pertaining to the feedback (e.g., in case of HARQ A/N feedback).

A default configuration for the transmission of UCI may be, for example, for the transmission of UCI on PUCCH (e.g., always a first TTI such as 1 ms TTI on PCell).

Further examples are provided below.

An applicable resource may be a PUSCH or PUCCH resource. A WTRU may determine a physical channel to perform the transmission of UCI using any technique, procedure or algorithm. For example, a WTRU may determine that UCI may be included in a PUSCH transmission when the transmission is scheduled, when simultaneous PUSCH and PUCCH transmissions are not configured or on a PUCCH transmission (e.g., otherwise).

An applicable resource may be a PUSCH resource. A WTRU may perform the transmission of UCI on a PUSCH transmission according to a TTI duration associated with a PUSCH transmission, which may be determined using procedures described herein.

An applicable resource may be a PUCCH resource. A WTRU may determine that a PUCCH resource may be used for transmission of UCI according to any technique, procedure or algorithm applicable to LTE CA. For example, selection of a resource may be based on the first CCE of the DCI that scheduled a downlink transmission or based on a configuration (e.g. PUCCH format 3 or similar). Bundling and/or multiplexing may be applied, for example, when configured.

An applicable TTI may be function of the type of transmissions on the carrier frequency PUSCH or PUCCH. Transmission of UCI may use the principles of LTE CA whereby UCI corresponding to transmission on different cells, e.g., including time-shifted cells, may be multiplexed on a single transmission using a format that supports the required number of information bits (e.g., PUCCH format 3).

A PUCCH transmission may be performed on a PCell with a first (e.g., 1 ms TTI), where the first TTI may be a fixed TTI. A WTRU may perform PUCCH transmission on resources of an applicable serving cell (e.g., a PCell) according to a TTI duration associated with a concerned (e.g., pertinent) PCell, which may be determined using procedures described herein. In an example, a WTRU may transmit HARQ feedback using a single PUCCH transmission, which may use resources associated with a PCell (e.g. using a 1 ms TTI duration), for example, when a WTRU has HARQ A/N feedback to transmit for two slot-based time-shifted cells using PUCCH on the PCell according to a configuration for a given carrier frequency where the PCell uses a first (e.g., 1 ms) TTI.

A PUCCH transmission may be performed on a PCell with alignment in time with TTI being reported. A WTRU may perform PUCCH transmission on resources of an applicable serving cell (e.g. a PCell) according to a TTI duration associated with transmission(s) for which feedback is transmitted. A WTRU may have, for example, HARQ A/N feedback to transmit for two slot-based time-shifted cells using PUCCH on the PCell according to a configuration for a given carrier frequency. In an example, a WTRU may transmit in the first slot a HARQ feedback for a transmission associated with the first slot and may transmit the HARQ feedback for the other transmission in the second slot for the concerned subframe.

A PUCCH transmission may be performed on a PCell with TTI/ShTTI of the PCell. A WTRU may perform a PUCCH transmission on resources of an applicable serving cell (e.g. a PCell) according to a TTI duration associated with the PCell, which may be determined using procedures described herein. A PCell may be (e.g., otherwise) configured with a default TTI, such as a first (e.g., 1 ms) TTI or an ShTTI. A WTRU may have HARQ A/N feedback to transmit for two slot-based time-shifted cells using PUCCH on the PCell, e.g., according to a configuration for a given carrier frequency where the PCell uses ShTTI in the concerned subframe (e.g., based on a configuration aspect and/or an activation state such as ShTTI activated for a time-shifted SCell for the concerned subframe), In an example, a WTRU may transmit HARQ feedback using a single PUCCH transmission, which may use resources associated with the PCell using a ShTTI duration with an offset applicable to the PCell.

A WTRU may transmit HARQ A/N feedback, for example, based on an applicable WTRU processing time for a concerned (e.g., pertinent) HARQ process in a given subframe.

Processing time associated with a HARQ process may be specific to a TTI associated with a transmissions for a concerned process. Processing time may be specific to a serving cell, a transmission mode or may be indicated by DCI (e.g., from servCellID or CIF) associated with such transmissions for a concerned HARQ process. In an example, HARQ processing time may be the same for all HARQ processes associated with a serving cell configured with a specific TTI (e.g., an ShTTI). Processing time may be a fixed value (e.g., 1 ms), a multiple of an ShTTI, etc. Processing time may be determined for a transmission using ShTTI in subframe, the first available occasion in subframe n+2, where an occasion may correspond to a PUCCH or a PUSCH transmission with duration according to a first TTI or second TTI (e.g., ShTTI).

Systems, methods, and instrumentalities have been disclosed for multiplexing transmissions with different TTI duration. Latency may be reduced (e.g., in an LTE system), for example, by multiplexing transmissions with different TTI durations. TTI duration may be modeled using one or more time-shifted cell(s) for a given carrier frequency. A “logical” cell structure may correspond to an SCell. A PCell may logically maintain a TTI (e.g,. a first TTI) or may be configured with a second duration TTI (e.g., a shorter duration TTI (ShTTI)).

In an example, a WTRU may determine a TTI duration (e.g., first or second TTI) applicable to a transmission. For example, a WTRU may determine a TTI duration using cross-carrier scheduling. A WTRU may associate a TTI duration with a cell identity (e.g. servCellID). A WTRU may associate a TTI duration with a transmission mode (TM). A TTI duration may be indicated by Carrier Indicator Field (CIF). A TTI duration may be determined from an identity of a PRB subset applicable to transmissions and/or to a time-shifted cell within a subset of PRBs for a concerned carrier frequency. An applicable TTI duration and/or the identity of a slot/period applicable to a transmission within a subframe may be determined using MAC Activation/Deactivation. MAC Activation/Deactivation may be used to toggle between first and second TTIs (e.g. legacy TTI and ShTTIs) or between slot-based ShTTIs and/or may be used to determine zero, one or more TTI (e.g. ShTTI) period(s) within a subframe.

HARQ processing may be performed according to a first behavior (e.g. legacy behavior) for one or more (e.g. each) time-shifted cell(s), although there may be exceptions. An exception may be timing-relationships, which may be scaled according to an applicable TTI duration. HARQ A/N feedback formats may use LTE Carrier Aggregation (CA) formats and/or (e.g., legacy) subframe-based timing relationships or a timing relationship associated with the HARQ process. Downlink Control Information (DCI) signaling may use a first (e.g., legacy) format, although, for example, interpretation of fields such as the CIF and/or PRBs applicable for the transmission may be different than the first (e.g., legacy) format. MAC activation/deactivation signaling may be applicable for time-shifted cells. DRX Timers associated with DRX may scale to HARQ A/N timing according to an applicable TTI duration and/or to the cell associated with an HARQ process. PRACH resources and/or PDCCH order for RACH may or may not be supported for time-shifted SCells. Timing advance for uplink transmission may be time shifted, for example, according to a shift applied to the TTI associated with a cell. Time shift may be relative to PCell timing, e.g. a PCell may remain a DL timing reference for an SCell with the additional offset corresponding to the start of the ShTTI for those cells.

A different TTI may be used in LTE R14 and NR. Multiple serving cells may be configured on the same carrier for a single WTRU. There may be an association between a serving cell and a TTI duration (or more generally—a numerology-related aspect). A WTRU can be configured with multiple such cells on a given carrier to support (e.g., dynamically) a change in transmission duration. A field in downlink control signaling (DCI), e.g., on a downlink control channel (e.g., PDCCH), such as the CIF field in a DCI, may be used to dynamically schedule specific TTI durations for same or later subframes, for UL or DL transmissions.

The WTRU may be configured with a plurality of transmission methods, where at least two of the configured transmission methods differ in at least the applicable TTI duration.

A transmission may be associated with a transmission timing (start offset) relative to a timing reference.

A WTRU transmission mode may be indicated in downlink control information (DCI) signaling.

WTRU transmissions may be configured for each of a plurality of PRBs in the WTRU's configuration. Each of a plurality of PRBs may correspond to a serving cell of the WTRU's configuration. Each of a plurality of PRBs may correspond to a given carrier.

An applicable transmission duration/timing may be determined from a serving cell ID indicated in DCI signaling.

The WTRU may determine the set of resources, transmission duration, and/or uplink control information for a transmission based on a previous combination of received downlink signaling and received transmission duration.

A WTRU may determine whether a control region (e.g., single control region) (e.g., single level PDCCH) or multiple control regions (e.g., multi-level PDCCH) are applicable and whether they are a function of the PDCCH configuration applicable to the concerned cell(s). A WTRU can determine the location of CCEs with respect to the timing reference (e.g., in support of either self-scheduling or cross-TTI scheduling).

A WTRU may support mini-slots (e.g., 125 usec), slots (e.g., 0.5 ms), subframe (e.g., 1 ms) and multi-slots (e.g., Multiples of other durations), and transmission durations and use different (e.g., shortened) TTI's based on these time allocations. This may provide a low latency mode, a throughput mode and/or a coverage mode.

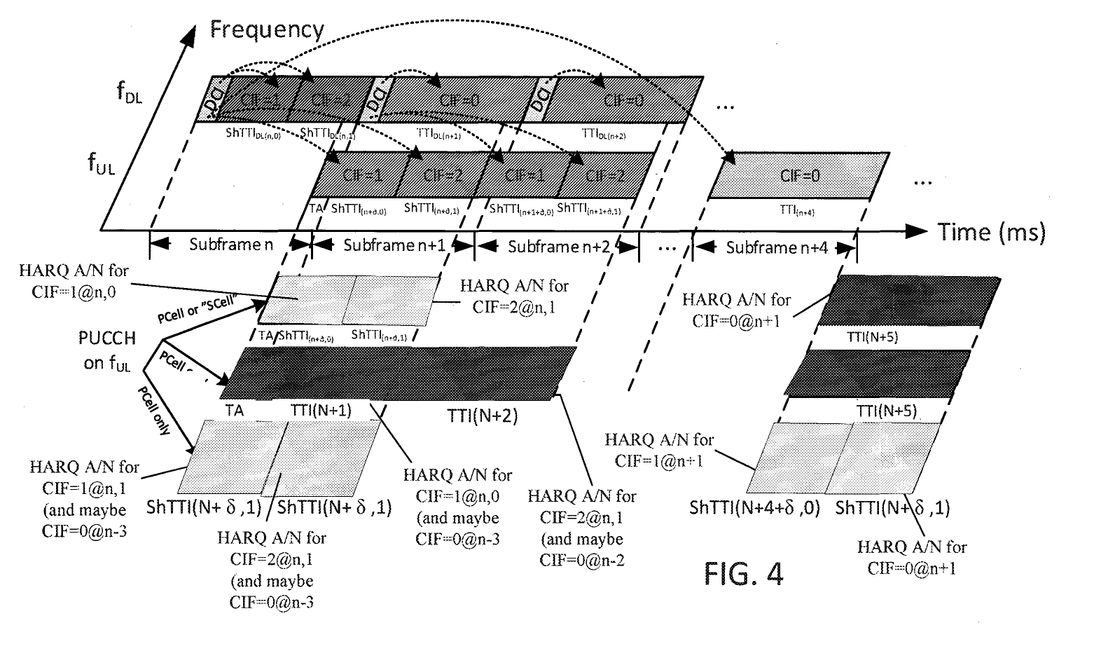

FIG. 4 depicts a scheduling example with time shifted-cells. As shown, there is a frequency axis and a time axis. In FIG. 4, the time is measured in milliseconds and divided into subframes. Other time units can be used such as slots, minislots, symbols, and PRB lengths. The frequency axis shows downlink (DL) and uplink (UL) transmissions. The time axis shows subframes. N, n+1, N=3, etc . . . . As shown for the DL frequency, for one or more subframes, the WTRU may receive DCI. For subframe n, the DCI may indicate two allocations, for example two ShTTI allocations (e.g., ShTTI_{DL(n,0)} and ShTTI_{DL(n,1)}). As an example, setting the CIF equal to 1 may indicate that the allocation is for ShTTI_{DL(n,0)} and setting the CIF equal to 2 may indicate the allocation is for ShTTI_{DL(n,1)}. Other values of the CIF may be used to indicate no ShTTI transmissions and/or different transmission durations. For example, the DCI in Subframe n+1 may indicate that for DL subframe n+1, the transmission has a duration corresponding to the entire subframe by using the value CIF=0 (see e.g., a TTI_{DL(N+1)}).

A similar signaling mechanism can be used for indicating different durations of uplink transmissions. For example, DCI in DL subframe n may indicate that the WTRU has received two uplink grants. For example, a first grant for subframe n+1 may be indicate a CIF=1, which may be configured to correspond to ShTTI_{(n+an offset,0)}, while a CIF equal to 2 may indicate a grant for ShTTI_{(n+an offset,0)}. Similarly, a different value of the CIF (e.g., CIF=0) in this example may indicate that the transmissions duration spans an entire legacy TTI as illustrated in FIG. 4. Thus, by associating different CIF values with different transmission durations, the DCI may be used to indicate different transmission durations by referencing the different CIF values. Although the CIF field is used for purposes of illustration, other DCI fields may be used and may have values mapped to/associated with transmissions of different duration.

FIG. 4 also shows for an example of the PUCCH on the uplink frequency. For the PCell or SCell there may be a HARQ A/N for CIF=1 at (n, 0) and a HARQ A/N for CIF=2 at n, 1. For the PCell, (e.g., PCell only), there may be a HARQ A/N for CIF=0 at (n, 0) or CIF=0 at n−3. Also, for the PCell, (e.g., PCell only), there may be a HARQ A/N for CIF=1 at (n, 0) or CIF=0 at n−3 for the ShTTI_{(n+?, 0)} and HARQ A/N for CIF=2 at (n, 1) or CIF=0 at n−3 for the ShTTI_{(n+?, 1)}.

FIG. 4 shows an example with time shifted cells with an offset of symbols. In this example, the symbol offset is based on CIF. FIG. 4 shows a single HARQ addressing space per TTI duration and start offset in a given subframe. MAC activation/deactivation may be applied by a HARQ process space or CIF value. FIG. 4 also shows a UCI example with time-shifted cells. The first CCE of the DCI on the example channel, PDCCH, may be used for legacy PUCCH resource allocation at TTI or ShTTI. Configured LTE CA PUCCH, PUCCH on an SCell, and/or ARI may be used for UCI using different TTIs. As shown, the WTRU interprets the DCI TTI indication differently in the FIG. 4 example for SCells and PCells to use ShTTI for the SCells. FIG. 4 also shows an example of the frequency being the same for the PCell and SCell. The FIG. 4 example dynamically varies the scheduled TTI for a WTRU and uses the appropriate HARQ signaling. Also, resource allocation for associated control information is resolved and there is flexibility to adapt different time offsets in a subframe and with different ShTTIs.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, optical media such as CD-ROM disks, and digital versatile disks (DVDs). A processor in association with software may be used to implement a radio frequency transceiver for use in a WTRU, WTRU, terminal, base station, RNC, or any host computer.

1. A method implemented by a wireless transmit/receive unit (WTRU) for supporting transmissions of different durations, the method comprising:
receiving a first configuration associated with a first set of transmission resources, the first configuration indicating a first transmission time interval (TTI) length for use with the first set of transmission resources;
receiving a second configuration associated with a second set of transmission resources, the second configuration indicating a second transmission time interval (TTI) length for use with the second set of transmission resources;
receiving downlink control information (DCI), wherein the DCI comprises a field that indicates whether the DCI is applicable to first set of transmission resources or the second set of transmission resources; and
determining that a transmission associated with the DCI utilizes the first TTI length on condition that the field indicates that the DCI is applicable to the first set of transmission resources or that the transmission associated with the DCI utilizes the second TTI length on condition that the field indicates that the DCI is applicable to the second set of transmission resources.

2. The method of claim 1, wherein the first set of transmission resources correspond to a first serving cell and the second set of transmission resources correspond to a second serving cell.

3. The method of claim 2, wherein the field corresponds to a carrier indicator field.

4. The method of claim 2, wherein the first serving cell and the second serving cell are associated with the same carrier frequency.

5. (canceled)

6. The method of claim 2, wherein the first serving cell corresponds to a primary cell (PCell), the second serving cells is configured as a secondary cells (SCell), the first TTI length corresponds to 1 millisecond (ms), and the second TTI length corresponds to less than 1 ms.

7. The method of claim 1, wherein the DCI further comprises a physical resource block (PRB) assignment field, and the PRB assignment field is interpreted differently depending on whether the transmission is associated with the first TTI length or the second TTI length.

8. (canceled)

9. (canceled)

10. A method implemented by a wireless transmit/receive unit (WTRU) for supporting transmissions of different durations, the method comprising:
receiving downlink control information from a first serving cell in the wireless communications network;
determining that the received downlink control information indicates that the WTRU should use a first transmission time interval to transmit data information to the first serving cell;
determining whether the received downlink control information indicates that the WTRU should use a second transmission time interval that is different than the first transmission time interval to communicate with the wireless communication network on the physical uplink channel; and
communicating with the wireless communications network using the second transmission time interval.

11. The method of claim 10, wherein determining that the received downlink control information indicates that the WTRU should use a second transmission time interval that is less than the first transmission time interval to communicate with the wireless communication network on the physical uplink channel comprises determining based on a carrier indicator field in the received downlink control information.

12. The method of claim 10, wherein communicating with the wireless communications network using the second transmission time interval comprises communicating with the first serving cell using the second transmission time interval.

13. The method of claim 10, wherein communicating with the wireless communications network using the second transmission time interval comprises communicating with a secondary cell using the second transmission time interval.

14. The method of claim 10, further comprising determining that the WTRU should use a third transmission time interval that is less than the first transmission time interval to communicate with a secondary cell in the wireless communications network.

15. The method of claim 10, wherein the shorten transmission time interval corresponds to at least one of at least one symbol or at least one resource block.

16. (canceled)

17. (canceled)

18. The method of claim 10, wherein the first transmission time interval corresponds to a first sub-carrier spacing and the second transmission time interval corresponds to a second subcarrier spacing.

19. (canceled)

20. (canceled)

21. (canceled)

22. (canceled)

23. (canceled)

24. A wireless transmit/receive unit (WTRU) for use within a wireless communications network that is capable of carrier aggregation, comprising:
a processor having executable instructions that:
determine that downlink control information from a first serving cell in the wireless communications network has been received;
determine that the received downlink control information indicates that the WTRU should use a first transmission time interval to transmit data information to the first serving cell;
determine whether the received downlink control information indicates that the WTRU should use a second transmission time interval that is different than the first transmission time interval to communicate with the wireless communication network on the physical uplink channel; and
communicate with the wireless communications network using the second transmission time interval.

25. The WTRU of claim 24, wherein the processor further comprises executable instructions that determine that the received downlink control information indicates that the WTRU should use a second transmission time interval that is less than the first transmission time interval to communicate with the wireless communication network on the physical uplink channel comprises determining based on a carrier indicator field in the received downlink control information.

26. The WTRU of claim 24, wherein the executable instructions that communicate with the wireless communications network using the second transmission time interval comprise communicating with the first serving cell using the second transmission time interval.

27. The WTRU of claim 24, wherein the executable instructions that communicate with the wireless communications network using the second transmission time interval comprise communicating with a secondary cell using the second transmission time interval.

28. The WTRU of claim 24, wherein the processor further comprises executable instructions that determine that the WTRU should use a third transmission time interval that is less than the first transmission time interval to communicate with a secondary cell in the wireless communications network.

29. The WTRU of claim 24, wherein the shorten transmission time interval corresponds to at least one of at least one symbol or at least one resource block.

30. (canceled)

31. The WTRU of claim 24, wherein the processor further comprises executable instructions that determine a time to transmit with the second transmission time interval based on the received downlink control information.

32. (canceled)

33. (canceled)

34. (canceled)

35. (canceled)

36. (canceled)

37. (canceled)
